(19) United States
(12) Patent Application Publication
(10) Pub. No.: US 2007/0075246 A1
(43) Pub. Date: Apr. 5, 2007

(54) Method of detecting concealed objects

(76) Inventor: Refael Gatt, Rakefet (IL)

Correspondence Address: NATH & ASSOCIATES, 112 South West Street, Alexandria, VA, 22314, US

(21) Appl. No.: 10/568,815

(22) PCT Filed:
(86) PCT No.: PCT/IL04/00763

(30) Foreign Application Priority Data
Aug. 21, 2003 (IL) 157520

(51) Int. Cl. G01J 5/02

(52) U.S. Cl. 250/341.6

(57) ABSTRACT

An object (12) concealed in a body (16) is detected by transiently heating or cooling at least part of the body surface, imaging that part of the surface in the mid- or far infrared, and seeking the concealed object (12) in the image(s). Alternatively, the body (16) is imaged as the temperature of its environment fluctuates naturally. Preferably, multiple infrared images are acquired and are processed to provide a measure of the body's thermal diffusivity, the object (12) then being sought according to that measure of thermal diffusivity. Most preferably, the heated/cooled part of the surface is imaged in the visible or near-infrared band too, and the two sets of images are processed together to provide the measure of the body's thermal diffusivity.

### FIELD AND BACKGROUND OF THE INVENTION

The present invention relates to the remote detection of concealed objects and, more particularly, to a method and system for remotely detecting a dangerous object (e.g. a bomb) carried by a person under his or her garments.

Most of the known methods for detecting concealed explosives require close proximity to the bearer of the explosives. These methods include, for example, metal detection, X-ray scanning, gas chromatography and mass spectroscopy. One exception is laser spectroscopy, which is allegedly capable of detecting suspicious vapors at a distance of several meters. A common feature of all these prior art methods is that they are oriented towards detecting specific properties of the suspected explosives.

The temperature T of a generally solid body obeys Fourier's law:

$$\frac{\partial T ( {r}^{->} , t )}{\partial t} = κ ( {r}^{->} ) {∇}^{2} T ( {r}^{->} , t )$$

where \vec{r} is spatial position within the body, t is time and κ(\vec{r}) is the thermal diffusivity of the body. κ(\vec{r}) is a function of the material composition of the body. In the steady state case, the temperature distribution of the body obeys Laplace's equation and is therefore dependent only on surface boundary conditions and not on bulk properties. Only in the transient state is the full, time-dependent Fourier law applicable. Therefore, the response of a generally solid body to a thermal perturbation is indicative of the material composition of the body.

### SUMMARY OF THE INVENTION

The present method is oriented towards exploiting a property of people (or exothermic organisms generally) that facilitates the detection of explosives and similar dangerous objects concealed beneath a person's garments. This property is the thermal regulation of the human body. In the presence of environmental temperature changes of tens of degrees, the temperature of the human body remains constant to within a fraction of a degree. The human body thus is an ideal background for the thermal detection of concealed, thermally passive objects.

Therefore, according to the present invention there is provided a method of detecting a concealed object, including the steps of: (a) transiently changing a temperature of at least part of a body at which the object is concealed; (b) acquiring at least one infrared image of at least a first part of a surface of the body; and (c) seeking the concealed object in the at least one infrared image.

Furthermore, according to the present invention there is provided a system for detecting a concealed object, including: (a) a mechanism for transiently changing a temperature of at least part of a body at which the object is concealed; and (b) a first camera for acquiring an infrared image of at least a first part of a surface of the body.

Furthermore, according to the present invention there is provided a method of detecting a concealed object, including the steps of: (a) acquiring at least one infrared image of at least a first part of a surface of a body at which the object is concealed while a temperature of at least part of the body fluctuates; and (b) seeking the concealed object in the at least one infrared image.

Furthermore, according to the present invention there is provided a system for detecting a concealed object, including: (a) a first camera for acquiring at least one infrared image of at least a first part of a surface of a body at which the object is concealed; (b) a memory for storing the at least one infrared image; and (c) a processor for processing the at least one infrared image to identify the concealed object.

In the basic method of the present invention, for detecting an object concealed in a body (e.g., an object concealed under a person's garment), at least part of the body is transiently heated or cooled. Then one or more infrared images of at least part of the surface of the body is/are acquired, and the concealed object is sought in the image(s). In the case of the body being a person suspected of concealing the object under his or her garment, preferably the garment is pressed against the suspected concealed object.

Preferably, the infrared image(s) is/are acquired in the three to five micron wavelength band or in the eight to twelve micron wavelength band.

Preferably, at least one other infrared image, of at least another part of the surface of the body, is acquired from a point of view different from the point of view from which the first set of one or more infrared images is acquired. The concealed object is sought in the infrared images acquired from both points of view.

Preferably, a plurality of infrared images is acquired. The images then are processed to provide a measure of the thermal diffusivity of the body. Alternatively, a corresponding plurality of reference images of the heated/cooled at least part of the surface of the body is acquired, and the infrared images and the reference images are processed together to provide a measure of the thermal diffusivity of the body. The processing may be digital processing, optical processing or analog processing. The concealed object is identified according to the measure of thermal diffusivity. Most preferably, the reference images are acquired in the visible wavelength band or in the near-infrared wavelength band. Also most preferably, the infrared images and the reference images are acquired substantially simultaneously.

Preferably, if the concealed object is identified in the infrared image(s), the body is immobilized.

Preferable applications of the method of the present invention include industrial applications and medical applications.

A basic system of the present invention includes a mechanism for transiently heating or cooling at least part of the body and a first camera for acquiring an infrared image of at least part of the surface of the body. Preferably, the first camera is operative to acquire the infrared image in the three to five micron wavelength band or in the eight to twelve micron wavelength band.

Preferably, the system also includes another camera for acquiring another infrared image of another at least part of the surface of the body from a point of view different than that from which the first infrared image is acquired.

Preferably, the camera is operative to acquire a plurality of the infrared images, and the system also includes a memory for storing the infrared images and a processor for processing the infrared images to identify the concealed object, e.g. by processing the images to provide a measure of the thermal diffusivity of the body. The processor may be a digital processor, an optical processor or an analog processor. More preferably, the system also includes a second camera for acquiring a corresponding plurality of reference images of the heated/cooled at least portion of the surface of the body. The reference images are stored in the memory along with the infrared images, and the processor is operative to process the infrared images and the reference images together to identify the concealed object, e.g. by processing the images to provide a measure of the thermal diffusivity of the body. Most preferably, the second camera acquires the reference images in the visible wavelength band. Also most preferably, the two cameras share a common field of view.

Alternatively, the camera is operative to acquire both a plurality of the infrared images and a corresponding plurality of the reference images, and the system also includes a memory for storing both kinds of images and a processor for processing both kinds of images to identify the concealed object, e.g. by processing the images to provide a measure of the thermal diffusivity of the body. The processor may be a digital processor, an optical processor or an analog processor. Most preferably, the camera acquires the reference images in the near infrared band.

Preferably, the system also includes a mechanism for immobilizing the body.

In a variant of the method of the present invention, the temperature of the body is not actively perturbed. Instead, one or more infrared images of the body, and also preferably a corresponding number of reference images of the body, are acquired e.g. during ambient temperature fluctuations of the body's environment. The corresponding system of the present invention lacks the mechanism for transiently heating or cooling the body.

### BRIEF DESCRIPTION OF THE DRAWINGS

The invention is herein described, by way of example only, with reference to the accompanying drawings, wherein:

FIG. 1 is a schematic illustration of a system of the present invention being used to intercept a would-be suicide bomber;

FIG. 2 is an infrared image of a person wearing a concealed simulated explosive belt;

FIG. 3 shows one way of providing the cameras of the system of FIG. 1 with a common field of view;

FIG. 4 is a partly schematic plan view of another system of the present invention.

### DESCRIPTION OF THE PREFERRED EMBODIMENTS

The present invention is of a method and system for detecting concealed objects. Specifically, the present invention can be used to detect explosive devices carried by would-be suicide bombers.

The principles and operation of concealed object detection according to the present invention may be better understood with reference to the drawings and the accompanying description.

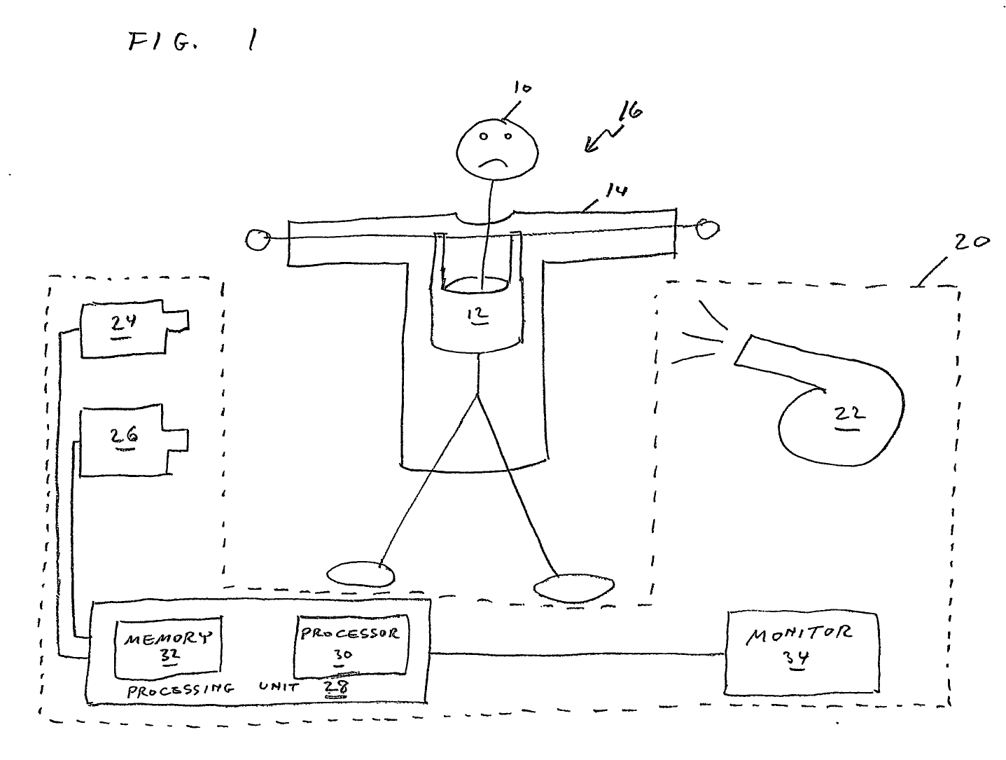

Referring now to the drawings, FIG. 1 shows a would-be suicide bomber 10, carrying an explosive belt 12 concealed beneath an outer garment 14, being detected by a system 20 of the present invention.

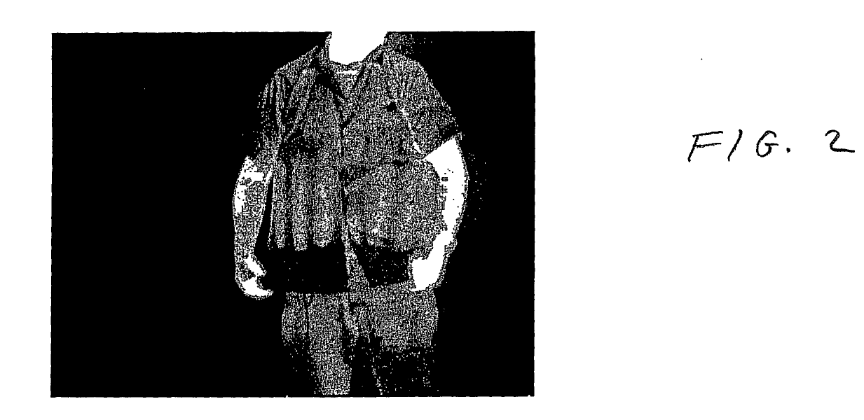

The combination of suicide bomber 10, explosive belt 12 and garment 14 is a generally solid body 16, and so obeys Fourier's law as described above. The response of body 16 to a thermal perturbation is indicative of the material composition of the body. Initially, body 16 is in a steady state, with both explosive belt 12 and garment 14 at a constant temperature. A hot air blower 22 is used to transiently heat body 16, elevating the temperature of at least a portion of explosive belt 12 and/or garment 14 above the initial temperature. A thermal camera 24 captures infrared images of body 16 while body 16 is heated by hot air blower 22 and while the elevated temperature of explosive belt 12 and garment 14 decays to the steady state temperature. These infrared images are displayed on a monitor 34. Each infrared image is a map of T(\vec{r},t) at the surface of body 16 at the time t at which that infrared image is acquired. κ(\vec{r}) of body 16 is inhomogeneous, and is sufficiently different in explosive belt 12 than in the rest of body 16 to render these infrared images diagnostic of the presence of explosive belt 12. FIG. 2 shows one such infrared image of a person carrying a simulated explosive belt beneath a shirt. This image was acquired using a Jade MWIR (mid-wavelength infrared) camera made by CEDIP Infrared Systems of Croissy Beauborg, France, with a nominal NETD (noise-equivalent temperature difference) of 30 mK at 25° C.

The camera used to acquire the image of FIG. 2 is sensitive in the mid infrared (three to five microns). This wavelength band gives infrared images with good contrast because the slope of the black body radiation curve at typical ambient temperatures is strongly positive in this wavelength band. The disadvantage of this band is that it requires that the sensor array of thermal camera 24 be cooled. Alternatively, thermal camera 24 is sensitive in the eight to twelve micron wavelength band. The resulting images have less contrast because this band is near the peak of the black body radiation curve at typical ambient temperatures, but sensor arrays for this wavelength band do not require cooling.

It is relatively straightforward for an operator of system 20 to detect an explosive belt carried beneath a shirt by inspection of the infrared images displayed on monitor 34. To detect a more skillfully concealed explosive belt, for example an explosive belt concealed beneath an overcoat, the infrared images are stored in a memory 32 of a processing unit 28 and processed by a processor 30 of processing unit 28. Solving the Fourier's law equation for κ(\vec{r}) gives:

$$κ ( {r}^{->} ) = \frac{\partial T ( {r}^{->} , t ) / \partial t}{{∇}^{2} T ( {r}^{->} , t )}$$

Given a pair of infrared images, the difference between the two images is proportional to ∂T(\vec{r},t)/∂t. For each infrared image, a finite difference approximation to the Laplacian of the infrared image is obtained; the sum of the two approximate Laplacians is proportional to ∇²T(\vec{r},t). Dividing the difference between the two images by the sum of the two approximate Laplacians provides a map of κ(\vec{r}) on the surface of body 16. The maps of κ(\vec{r}) obtained from successive pairs of infrared images are further processed using image processing methods familiar to those skilled in the art to provide a final map of κ(\vec{r}) that is displayed on monitor 34.

Processor 30 typically is a digital processor, and the infrared images are processed digitally. Alternatively, processor 30 is an optical processor or an analog processor, and the infrared images are processed optically or by analog means.

This procedure gives an adequate map of κ(\vec{r}) as long as body 16 does not move. To compensate for movement of body 16, a reference camera 26 is used to capture visible images of body 16 in the visible band substantially simultaneously with the capture of the infrared images of body 16 by thermal camera 24. The visible images are stored along with the infrared images in memory 32. Known image processing techniques are used by processor 30 to identify and track body 16 in the visible images. Processor 30 transfers the location of body 16 in each visible image to the corresponding infrared image, and registers the infrared images with each other to compensate for the movement of body 16 in the calculation of the map of κ(\vec{r}).

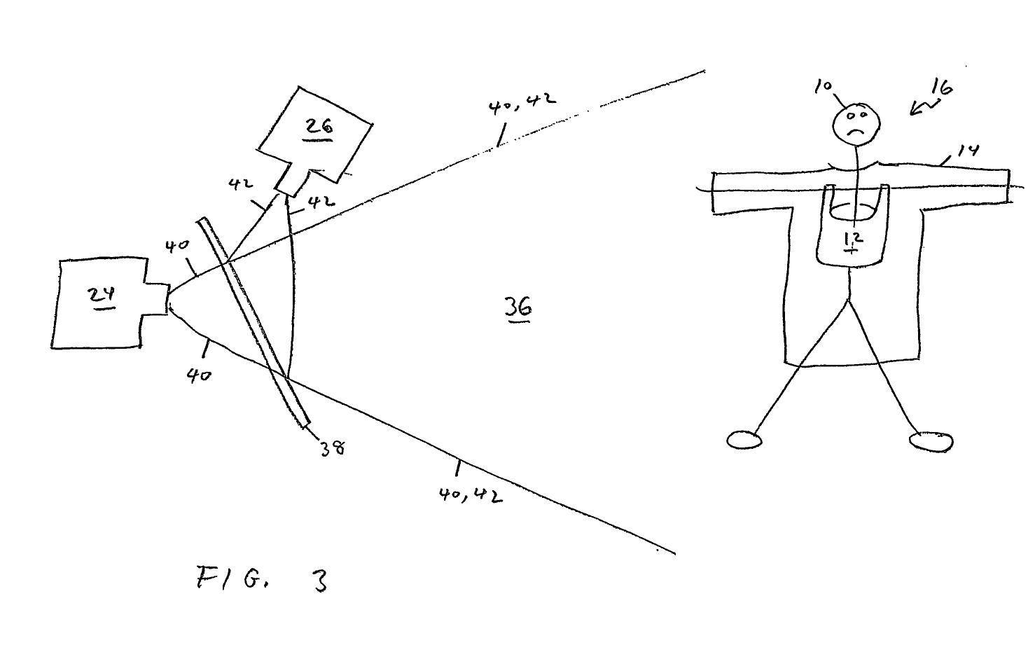

To facilitate the transfer of the location of body 16 from the visible images to the infrared images, it is preferable that cameras 24 and 26 have a common field of view. FIG. 3 illustrates one way of providing cameras 24 and 26 with a common field of view. Cameras 24 and 26 are positioned as shown relative to a plate 38 made of a material such as germanium that is transparent to infrared light and reflects visible light. Lines 40 are the bounds of the field of view of camera 24. Lines 42 are the bounds of the field of view of camera 26. Plate 38 passes infrared light from body 16 to camera 24 and reflects visible light from body 16 to camera 26.

In the illustrated example, hot air blower 22 is used to transiently heat a portion of body 16. Alternatively, a blast of cold air is used to transiently chill a portion of body 16. In the specific illustrated example of body 16, transiently heating or cooling body 16 with a stream of hot or cold air has the advantage of blowing on garment 14 to press garment 14 against explosive belt 12, thereby increasing the contrast between garment 14 and explosive belt 12 in the thermal images. To inspect people entering, e.g., a shopping mall, the entrance to the mall is equipped with a gate that directs heated or cooled air, depending on the season of the year, at people entering the mall. For remote inspection of people illegally crossing a border, an infrared laser or microwave radiation is used to transiently heat the people being inspected.

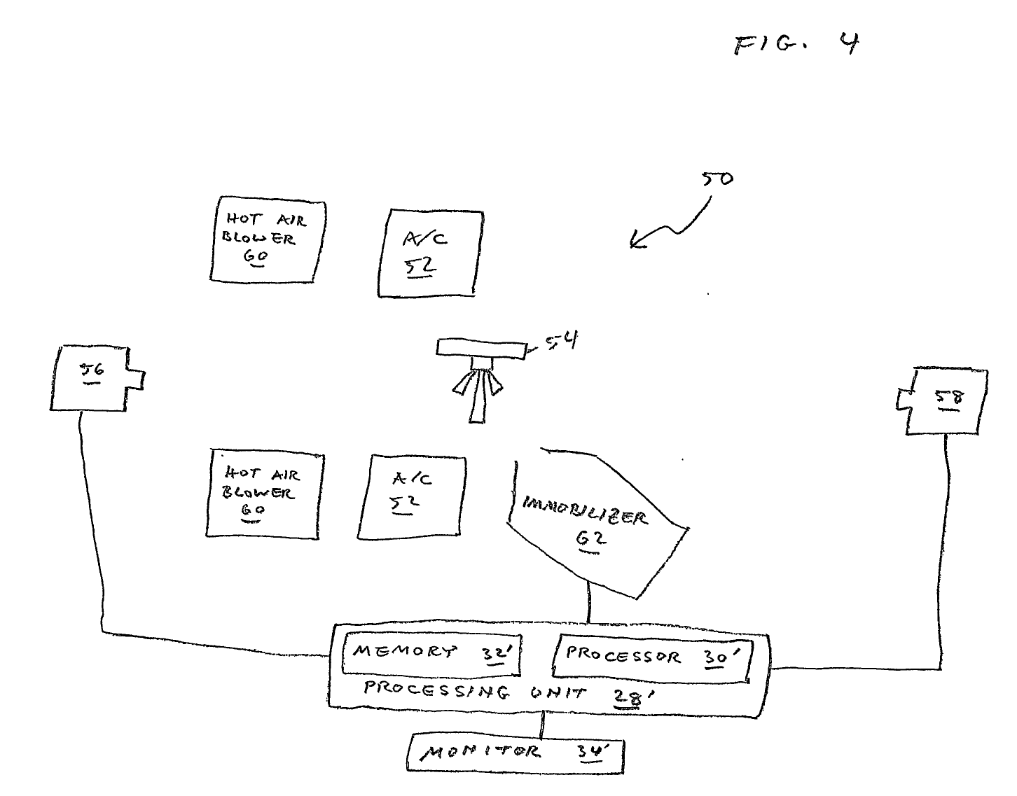

FIG. 4 is a partly schematic plan view of another system 50 of the present invention. Two hot air blowers 60 on opposite sides of an entrance corridor of e.g. a transportation facility transiently heat a person entering the corridor. A turnstile 54 delays the entrance of a person to the facility long enough for two air conditioning units 52 to blow cold air on the person, thereby transiently cooling the person, and for two cameras 56 and 58 to capture images of the person from two different points of view. Cameras 56 and 58 are multispectral cameras, sensitive in both an “ambient” infrared band, such as the three to five micron band or the eight to twelve micron band, in which ambient temperature contrasts can be imaged, and in a reference wavelength band, such as a visible band or a near infrared band, that is relatively insensitive to ambient temperature contrasts. Cameras 56 and 58 capture infrared images of the person at turnstile 54 in the ambient infrared band and reference images of the person at turnstile 54 in the reference wavelength band. Preferably, the reference wavelength band is a near infrared band because it is easier to make a sensor array that is sensitive in two infrared bands than to make a sensor array that is sensitive in both an ambient infrared band and a visible band. Cameras 56 and 58 then pass the acquired images to a processing unit 28′, that is substantially identical to processing unit 28 of system 20, with a memory 32′ and a processor 30′ that are substantially identical to memory 32 and processor 30 of system 20. System 50 also includes a monitor 34′ that is substantially identical to monitor 34 of system 20. Cameras 56 and 58 preferably are in stand-off positions relative to turnstile 54 so that if would-be suicide bomber 10 chooses to detonate explosive belt 12 at turnstile 54 cameras 56 and 58 are not damaged.

If processor 30′ identifies a dangerous concealed object such as explosive belt 12 in the images received from cameras 56 and 58, or if an operator of system 50 identifies such a dangerous concealed object in the images displayed on monitor 34′, sticky foam is dispensed from a dispenser 62 to immobilize the person at turnstile 54. Alternatively, turnstile 54 is configured to direct people identified as dangerous in one exit direction and people identified as not dangerous in another exit direction.

Thermal cameras now are available that have a nominal NETD of 10 mK at ambient temperatures. These thermal cameras are sufficiently sensitive that ambient temperature fluctuations of the environment of a body such as body 16, for example due to breezes, are sufficient to produce enough contrast in the acquired infrared images of the body to allow a computation of κ(\vec{r}) as described above. A system of the present invention that uses such as thermal camera as camera 24 or as camera 56 is similar to system 20 or 50 as describe above but lacks a mechanism such as hot air blower 22 or air conditioner units 52 for transiently heating or cooling the body.

In addition to security applications such as those discussed above, the present invention also has applications in industry and medicine.

One industrial application of the present invention is to quality control in batch manufacturing. A defective item such as a computer chip that is manufactured in batches is likely to have voids or inclusions that are not present in an item that is free of defects. The defective item therefore is likely to have different thermal properties, and in particular a diferent thermal diffusivity κ(\vec{r}), than a defect-free item. The present invention detects defective items based on their anomalous thermal difusivities.

One medical application of the present invention is to the detection of shallow tumors such as breast tumors. A shallow tumor is likely to have a different κ(\vec{r}) than the surrounding normal tissue, because cancer cells have different biological properties (e.g. poorer thermoregulation) and different physical properties (e.g. density) than normal cells.

While the invention has been described with respect to a limited number of embodiments, it will be appreciated that many variations, modifications and other applications of the invention may be made.

What is claimed is:

1. A method of detecting a concealed object, comprising the steps of:
(a) transiently changing a temperature of at least part of a body at which the object is concealed;
(b) acquiring at least one infrared image of at least a first part of a surface of said body; and
(c) seeking the concealed object in said at least one infrared image.

2. The method of claim 1, wherein said body includes a person and wherein the object is concealed under a garment worn by said person.

3. The method of claim 2, further comprising the step of:
(d) pressing said garment against the object.

4. The method of claim 1, wherein said at least one infrared image is acquired in a wavelength band between about three microns and about five microns.

5. The method of claim 1, wherein said at least one infrared image is acquired in a wavelength band between about eight microns and about twelve microns.

6. The method of claim 1, wherein a plurality of said infrared images is acquired, the method further comprising the step of:
(d) processing said infrared images to provide a measure of a thermal diffusivity of said body, the concealed object then being sought according to said measure of said thermal diffusivity.

7. The method of claim 6, wherein said processing is selected from the group consisting of digital processing, optical processing and analog processing.

8. The method of claim 1, further comprising the step of:
(d) acquiring at least one infrared image of at least a second part of a surface of said body, from a different point of view than said at least one infrared image of said at least first part of said surface of said body, said concealed object then being sought both in said at least one infrared image of said at least first part of said surface of said body and in said at least one infrared image of said at least second part of said body.

9. The method of claim 1, wherein a plurality of said infrared images is acquired, the method further comprising the steps of:
(d) acquiring a corresponding plurality of reference images of said at least first part of said surface of said body; and
(e) processing said infrared images and said reference images to provide a measure of a thermal diffusivity of said body, the concealed object then being sought according to said measure of said thermal diffusivity.

10. The method of claim 9, wherein said processing is selected from the group consisting of digital processing, optical processing and analog processing.

11. The method of claim 9, wherein said reference images are acquired in a visible wavelength band.

12. The method of claim 9, wherein said reference images are acquired in a near-infrared wavelength band.

13. The method of claim 9, wherein said infrared images and said reference images are acquired substantially simultaneously.

14. The method of claim 1, further comprising the step of:
(d) if the concealed object is identified in said at least one infrared image: immobilizing said body.

15. The method of claim 1, wherein said transient change of said temperature is a transient increase of said temperature.

16. The method of claim 1, wherein said transient change of said temperature is a transient decrease of said temperature.

17. The method of claim 1, for industrial use.

18. The method of claim 1, for medical use.

19. A system for detecting a concealed object, comprising:
(a) a mechanism for transiently changing a temperature of at least part of a body at which the object is concealed; and
(b) a first camera for acquiring an infrared image of at least a first part of a surface of said body.

20. The system of claim 19, wherein said mechanism is operative to transiently increase said temperature.

21. The system of claim 19, wherein said mechanism is operative to transiently decrease said temperature.

22. The system of claim 19, wherein said first camera is operative to acquire said infrared images in a wavelength band between about three microns and about five microns.

23. The system of claim 19, wherein said first camera is operative to acquire said infrared image in a wavelength band between about eight microns and about twelve microns.

24. The system of claim 19, further comprising:
(c) a second camera for acquiring an infrared image of at least a second part of a surface of said body from a different point of view than said infrared image acquired by said first camera.

25. The system of claim 19, wherein said first camera is operative to acquire a plurality of said infrared images.

26. The system of claim 25, further comprising:
(c) a memory for storing said infrared images; and
(d) a processor for processing said infrared images to identify the concealed object.

27. The system of claim 26, wherein said processor is selected from the group consisting of a digital processor, an optical processor and an analog processor.

28. The system of claim 26, further comprising:
(e) a second camera for acquiring a corresponding plurality of reference images of said at least first part of said surface of said body, said memory being operative to store said reference images, said processor being operative to process both said infrared images and said reference images to identify the concealed object.

29. The system of claim 28, wherein said second camera is operative to acquire said reference images in a visible wavelength band.

30. The system of claim 28, wherein said first and second cameras have a common field of view.

31. The system of claim 26, wherein said first camera is operative to acquire a corresponding plurality of reference images of said at least first part of said surface of said body, said memory being operative to store said reference images, said processor being operative to process both said infrared images and said reference images to identify the concealed object.

32. The system of claim 31, wherein said first camera is operative to acquire said reference images in a near-infrared wavelength band.

33. The system of claim 19, further comprising:
(e) a mechanism for immobilizing said body.

34. A method of detecting a concealed object, comprising the steps of:
(a) acquiring at least one infrared image of at least a first part of a surface of a body at which the object is concealed while a temperature of at least part of said body fluctuates; and
(b) seeking the concealed object in said at least one infrared image.

35. The method of claim 34, wherein said body includes a person and wherein the object is concealed under a garment worn by said person.

36. The method of claim 35, further comprising the step of:
(c) pressing said garment against the object.

37. The method of claim 34, wherein said at least one infrared image is acquired in a wavelength band between about three microns and about five microns.

38. The method of claim 34, wherein said at least one infrared image is acquired in a wavelength band between about eight microns and about twelve microns.

39. The method of claim 34, further comprising the step of:
(c) acquiring at least one infrared image of at least a second part of a surface of said body, from a different point of view than said at least one infrared image of said at least first part of said surface of said body, said concealed object then being sought both in said at least one infrared image of said at least first part of said surface of said body and in said at least one infrared image of said at least second part of said body.

40. The method of claim 34, wherein a plurality of said infrared images is acquired, the method further comprising the step of:
(c) processing said infrared images to provide a measure of a thermal diffusivity of said body, the concealed object then being sought according to said measure of said thermal diffusivity.

41. The method of claim 40, wherein said processing is selected from the group consisting of digital processing, optical processing and analog processing.

42. The method of claim 34, wherein a plurality of said infrared images is acquired, the method further comprising the steps of:
(c) acquiring a corresponding plurality of reference images of said at least first part of said surface of said body; and
(d) processing said infrared images and said reference images to provide a measure of a thermal diffusivity of said body, the concealed object then being sought according to said measure of said thermal diffusivity.

43. The method of claim 42, wherein said processing is selected from the group consisting of digital processing, optical processing and analog processing.

44. The method of claim 42, wherein said reference images are acquired in a visible wavelength band.

45. The method of claim 42, wherein said reference images are acquired in a near-infrared wavelength band.

46. The method of claim 42, wherein said infrared images and said reference images are acquired substantially simultaneously.

47. The method of claim 34, further comprising the step of:
(c) if the concealed object is identified in said at least one infrared image: immobilizing said body.

48. The method of claim 34, for industrial use.

49. The method of claim 34, for medical use.

50. A system for detecting a concealed object, comprising:
(a) a first camera for acquiring at least one infrared image of at least a first part of a surface of a body at which the object is concealed;
(b) a memory for storing said at least one infrared image; and
(c) a processor for processing said at least one infrared image to identify the concealed object.

51. The system of claim 50, wherein said processor is selected from the group consisting of a digital processor, an optical processor and an analog processor.

52. The system of claim 50, wherein said first camera is operative to acquire said at least one infrared image in a wavelength band between about three microns and about five microns.

53. The system of claim 50, wherein said first camera is operative to acquire said at least one infrared image in a wavelength band between about eight microns and about twelve microns.

54. The system of claim 50, further comprising:
(d) a second camera for acquiring an infrared image of at least a second part of a surface of said body from a different point of view than said infrared image acquired by said first camera.

55. The system of claim 50, wherein said first camera is operative to acquire a plurality of said infrared images.

56. The system of claim 55, wherein said processor is operative to process said plurality of said infrared images to provide a measure of a thermal diffusivity of said body, the concealed object then being identified according to said measure of said thermal diffusivity.

57. The system of claim 55, further comprising:
(d) a second camera for acquiring a corresponding plurality of reference images of said at least first part of said surface of said body, said memory being operative to store said reference images, said processor being operative to process both said infrared images and said reference images to identify the concealed object.

58. The system of claim 57, wherein said second camera is operative to acquire said reference images in a visible wavelength band.

59. The system of claim 57 wherein said first and second cameras have a common field of view.

60. The system of claim 55, wherein said first camera is operative to acquire a corresponding plurality of reference images of said at least first part of said surface of said body, said memory being operative to store said reference images, said processor being operative to process both said infrared images and said reference images to identify the concealed object.

61. The system of claim 60, wherein said first camera is operative to acquire said reference images in a near-infrared wavelength band.

62. The system of claim 50, further comprising:
(d) a mechanism for immobilizing said body.
